(19) United States
(12) Patent Application Publication
(10) Pub. No.: US 2025/0234928 A1
(43) Pub. Date: Jul. 24, 2025

(54) ATOMIZER AND ELECTRONIC CIGARETTE

(71) Applicant: SHENZHEN SMOORE TECHNOLOGY LIMITED, SHENZHEN (CN)

(72) Inventor: Jiyun HAN, Shenzhen (CN)

(73) Assignee: SHENZHEN SMOORE TECHNOLOGY LIMITED, SHENZHEN (CN)

(21) Appl. No.: 19/172,705

(22) Filed: Apr. 8, 2025

Related U.S. Application Data
(63) Continuation of application No. 16/380,936, filed on Apr. 10, 2019.

(30) Foreign Application Priority Data
May 4, 2018 (CN) 201820666215.0

(51) Int. Cl. A24F 40/485; A24F 40/10; A24F 40/44; A24F 40/46; H05B 3/18; H05B 3/46

(52) U.S. Cl. CPC A24F 40/485; A24F 40/44; A24F 40/46; H05B 3/18; H05B 3/46; A24F 40/10

(57) ABSTRACT

An atomizer and an electronic cigarette are disclosed. The atomizer includes a shell defining a smoke outlet communicating with outside environment, a liquid cavity capable of storing a fluid to be vaporized and an atomizing chamber. A heating assembly located inside the shell, wherein the heating assembly comprises a liquid guiding member, a cover and a heating component. The cover is an integral structure defining a liquid tunnel and a smoke tunnel, the liquid tunnel communicates with the liquid cavity and extends to the liquid guiding member, and the smoke outlet communicates with the atomizing chamber via the smoke tunnel. The liquid guiding member is configured to transport the fluid from the liquid tunnel to the atomizing chamber, and to heat the fluid to generate smoke. The heating component is connected with the liquid guiding member to heat the liquid guiding member.

### CROSS-REFERENCE TO RELATED APPLICATIONS

The present application is a continuation of patent application Ser. No. 16/380,936, filed Apr. 10, 2019, which claims foreign priority of Chinese Patent Application No. 201820666215.0, filed on May 4, 2018 in the National Intellectual Property Administration of China, the entire contents of which are hereby incorporated by reference.

### TECHNICAL FIELD

The present disclosure generally relates to electronic cigarettes, and in particular to an atomizer and an electronic cigarette.

### BACKGROUND

People are caring more about their health. Damage of traditional tobacco to the human body is well known. Thus, electronic cigarettes have been created. An electronic cigarette has a similar appearance and smell as a traditional cigarette, but typically does not contain the ingredient tar. Accordingly, damage from the electronic cigarette to the user may be less than that of the traditional cigarette.

An electronic cigarette is usually composed of an atomizer and a battery assembly. In related art, the heating assembly of the atomizer of the electronic cigarette usually consists of a fiber rope and a heating coil wrapped around the fiber rope.

### SUMMARY

The present disclosure provides an atomizer and an electronic cigarette.

The atomizer includes a liquid cavity, a liquid guiding member, a heating component, a cover, and a smoke outlet. The liquid cavity is configured for storing a fluid to be vaporized. The heating component is in contact with the liquid guiding member. The cover is an integral structure, a liquid tunnel and a smoke tunnel are defined at least partially in the cover, and the liquid tunnel is communicated with the liquid cavity and the liquid guiding member. The smoke outlet is communicated with the smoke tunnel, and smoke generated by heating the fluid is allowed to enter the smoke outlet through the smoke tunnel.

The electronic cigarette includes a power supply and an atomizer. The power supply is connected to the atomizer. The atomizer includes a liquid cavity, a liquid guiding member, a heating component, a cover, and a smoke outlet. The liquid cavity is configured for storing a fluid to be vaporized. The heating component is in contact with the liquid guiding member. The cover is an integral structure, a liquid tunnel and a smoke tunnel are defined at least partially in the cover, and the liquid tunnel is communicated with the liquid cavity and the liquid guiding member. The smoke outlet is communicated with the smoke tunnel, and smoke generated by heating the fluid is allowed to enter the smoke outlet through the smoke tunnel.

### BRIEF DESCRIPTION OF THE DRAWINGS

In order to clearly explain the technical solutions in the embodiments of the present disclosure, the drawings used in the description of the embodiments will be briefly described below. The drawings in the following description are merely some embodiments of the present disclosure. For those of ordinary skill in the art, other drawings may also be obtained based on these drawings without any creative work.

FIG. 1 shows a section view illustrating the inner structure of an atomizer according to an embodiment of the present disclosure.

FIG. 2 shows another section view illustrating the inner structure of the atomizer of FIG. 1 taken from another perspective.

FIG. 3 is a perspective view of a cover of an atomizer according to an embodiment of the present disclosure.

FIG. 4 is a perspective view of a liquid guiding member of an atomizer according to an embodiment of the present disclosure.

FIG. 5 is a perspective view of a chassis of an atomizer according to an embodiment of the present disclosure.

FIG. 6 is a perspective view of a sealing component of an atomizer according to an embodiment of the present disclosure.

FIG. 7 is a section view illustrating the inner structure of an electronic cigarette according to an embodiment of the present disclosure.

### DETAILED DESCRIPTION

The disclosure will now be described in detail with reference to the accompanying drawings and examples. Apparently, the described embodiments are only a part of the embodiments of the present disclosure, not all of the embodiments. All other embodiments obtained by a person of ordinary skill in the art based on the embodiments of the present invention without creative efforts shall fall within the protection scope of the present invention.

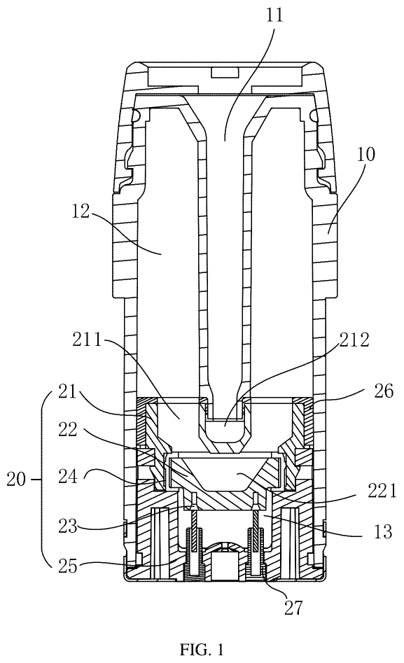

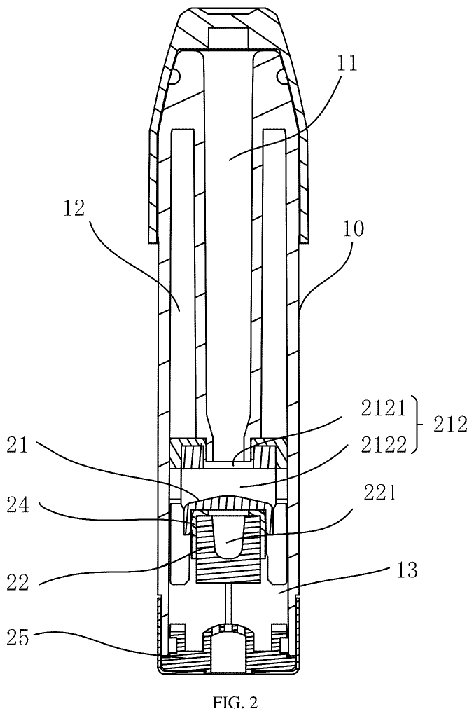

FIGS. 1 and 2 show the inner structure of an atomizer according to an embodiment of the present disclosure. The atomizer may include a shell 10 and a heating assembly 20.

The shell 10 may define a smoke outlet 11, a liquid cavity 12 and an atomizing chamber 13 separated from each other. The liquid cavity 12 may be capable of storing a fluid to be vaporized, e.g., liquid smoke. The smoke outlet 11 may communicate with environment outside of the shell 10, such that a user of the atomizer may suck the smoke generated inside the shell 10 through the smoke outlet 11.

The heating assembly 20 may be located inside the shell 10. The heating assembly 20 may separate the smoke outlet 11 and the liquid cavity 12 from the atomizing chamber 13. The heating assembly 20 may include a cover 21, a liquid guiding member 22 and a heating component 23.

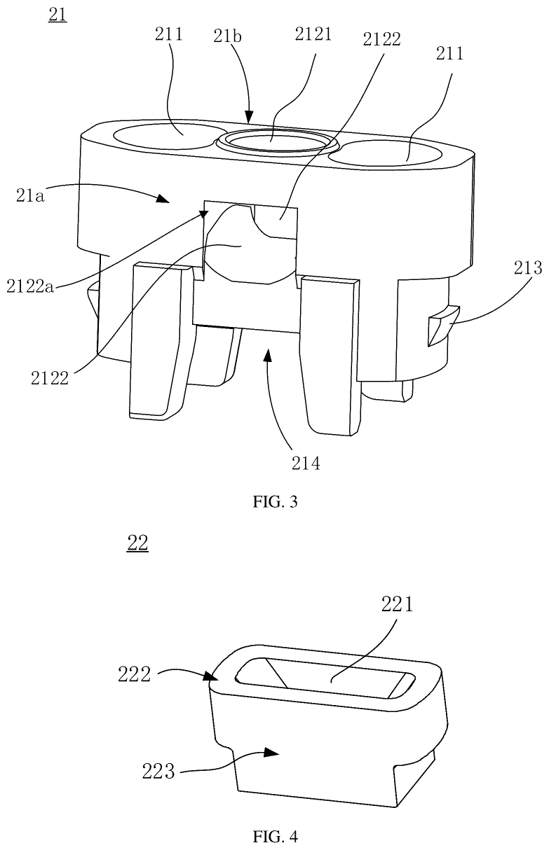

Referring also to FIG. 3, the cover 21 may be an integral structure. That is, the cover 21 may be a single piece. It may define a liquid tunnel 211 and a smoke tunnel 212. The liquid tunnel 211 may communicate with the liquid cavity 12 and extend to the liquid guiding member 22. It should be understood that although two liquid tunnels 211 and one smoke tunnel 212 are illustrated in the figures, the number of the liquid tunnel 211 and the smoke tunnel 212 is not limited. For example, the number of the liquid tunnel 211 may be one, two, three or more. By setting multiple liquid tunnels 211, fluid from the liquid tunnels 211 may be more evenly distributed on the surface of the liquid guiding member 22, thereby avoiding excessive heat in a certain portion of the liquid guiding member 22. The smoke outlet 11 may communicate with the atomizing chamber 13 via the smoke tunnel 212. In some embodiments, the cross-section of the liquid tunnel 211 may have a non-circular configuration. For example, the cross-section of the liquid tunnel 211 may be elliptical, rectangular, triangular or have an irregular shape. In this way, the liquid film is not likely to block the liquid tunnel 211.

The liquid guiding member 22 may be configured to transport the fluid from the liquid tunnel 211 to the atomizing chamber 13, and to heat the fluid to generate smoke in the atomizing chamber 13. The fluid from the liquid cavity 12 may pass through the liquid tunnel 211 and penetrate the liquid guiding member 22 under capillary action. During the penetration of the liquid guiding member 22, the fluid may be heated by the liquid guiding member 22 (since the liquid guiding member 22 is heated by the heating component 23) and be vaporized into smoke. Thus, smoke can be generated in the atomizing chamber 13.

The heating component 23 may be connected with the liquid guiding member 22. It may be utilized to heat the liquid guiding member 22 when powered. The heating component 23 may be in the shape of a coating coated on a surface of another component, a heating circuitry, a heating plate or any other suitable heating structure, which is not limited in the present disclosure.

According to the present disclosure, fluid stored in the liquid cavity 12 may arrive at the liquid guiding member 22 through the liquid tunnel 211. Then the fluid may penetrate the liquid guiding member 22 and be vaporized by the liquid guiding member 22 to generate smoke in the atomizing chamber 13. The smoke may then exit from the smoke tunnel 212 and the smoke outlet 11, which are interconnected together with the atomizing chamber 13 when a user uses the atomizer. The cover 21 of the atomizer is an integral structure, which may improve the sealing of the device and facilitate the installation of the device. The liquid tunnel 211 and the smoke tunnel 212 are both defined in the cover 21, which may make the inner structure of the atomizer more compact.

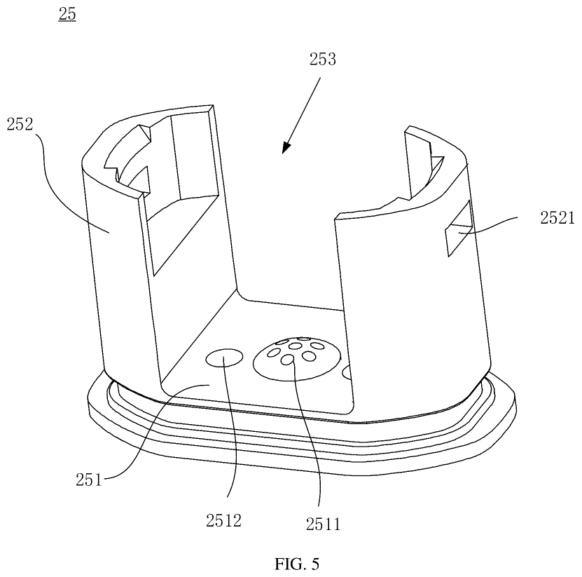

The liquid guiding member 22 may be a porous body, a liquid guiding rope, a guiding tube without a hole, and the like. In some embodiments, the liquid guiding member 22 may include porous ceramic, which may be formed by using a sintering process with aggregate, binder and pore-forming material. The porous ceramic is now used for a wide variety of industrial applications from filtration, absorption, catalysts, and catalyst supports to lightweight structural components. Pores may be interconnected with each other in the porous ceramic such that the liquid guiding member 22 made of porous ceramic may be capable of transporting the fluid (or smoke) from one of its surfaces to another. In some embodiments, the liquid tunnel 211 may extend to a first surface 222 (shown in FIG. 4) of the liquid guiding member 22, and a second surface 223 (shown in FIG. 4) of the liquid guiding member 22 may be at least partially exposed in the atomizing chamber 13. Thus, the liquid guiding member may be capable of transporting the fluid arriving at the first surface 222 to the second surface 223 and the atomizing chamber 13.

As shown in FIGS. 1, 2 and 4, in some embodiments, the liquid guiding member 22 may define a groove 221 through the first surface 222 of the liquid guiding member 22. That is, the groove 221 may be defined at a side of the liquid guiding member 22, which is close to the liquid tunnel 211. The groove 221 may be interconnected with the liquid tunnel 211. Optionally, the size of the groove 221 may gradually decrease along the thickness direction of the liquid guiding member 22 as shown in FIG. 1. When fluid from the liquid cavity 12 arrives at the liquid guiding member 22, the fluid may be temporarily stored in the groove 221. Thus, the contact area between the fluid and the liquid guiding member 22 may be increased, thereby increasing the diffusion speed of the fluid in the liquid guiding member 22. Furthermore, the implementation of the groove 221 may reduce the overall thickness of the liquid guiding member 22, thus reducing the flow resistance of the liquid guiding member 22.

In some embodiments, the cover 21 may cover the first surface 222 and one portion of the second surface 223 of the liquid guiding member 22. In this situation, another portion of the second surface 223 of the liquid guiding member 22 may be exposed in the atomizing chamber 13, as shown in FIG. 2. Specifically, the cover 21 may define an accommodating space 214 (as shown in FIG. 3), the opening of which faces towards the liquid guiding member 22. The liquid guiding member 22 may be partially received in the accommodating space 214. In this circumstance, a portion of the second surface 223 of the liquid guiding member 22 is covered by the side wall of the cover 21 while another portion is not. Fluid from the liquid cavity 12 (or smoke generated inside the liquid guiding member 22) may exit from the uncovered portion of the second surface 223.

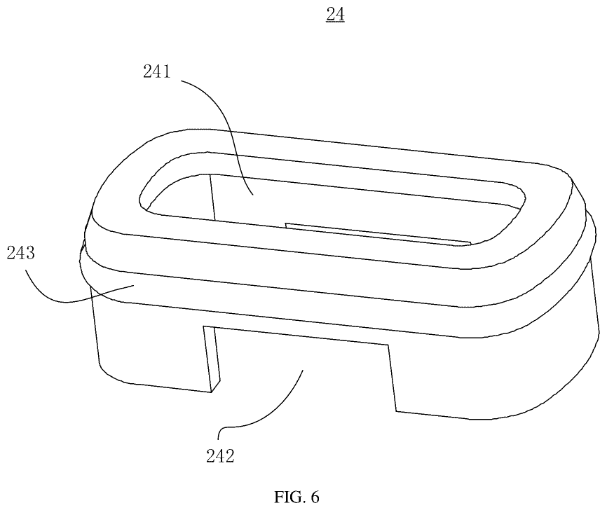

In some embodiments, the heating assembly 20 may further include a sealing component 24, as shown in FIGS. 1, 2 and 6. The sealing component 24 may be engaged between the cover 21 and the liquid guiding member 22. The sealing component 24 may define a through hole 241 extending from the liquid tunnel 21 to the first surface 222 of the liquid guiding member 22 such that the liquid tunnel 21 may still be interconnected with the first surface 222 of the liquid guiding member 22. The size and shape of the through hole 241 may correspond to those of the liquid tunnel 21 or the groove 221. Optionally, the sealing component 24 may be made of silicone. Since silicone may have high absorbability, high heat stability, steady chemical performance and high mechanical strength, the usage of silicone may ensure that the cover 21 and the liquid guiding member 22 are well sealed. The implementation of the sealing component 24 may prevent leakage between the cover 21 and the liquid guiding member 22. Specifically, the sealing component 24 may prevent fluid from entering the atomizing chamber 13 without passing through the liquid guiding member 22, and prevent smoke in the atomizing chamber 13 from returning to the liquid tunnel 211 and the liquid cavity 12.

In some embodiments, the first surface 222 may be the top surface of the liquid guiding member 22, and the second surface 223 may be a side surface adjacent to the top surface of the liquid guiding member 22. In this embodiment, the heating component 23 may be arranged on the bottom surface adjacent to the side surface (and opposite to the top surface) of the liquid guiding member 22.

Referring to FIGS. 2 and 3, in some embodiments, the smoke tunnel 212 of the cover 21 may be divided into a first sub-tunnel 2121 and a second sub-tunnel 2122. The first sub-tunnel 2121 may be opened from the upper surface of the cover 21, and communicate with the smoke outlet 11. The second sub-tunnel 2122 may be opened from the side surface of the cover 21, and further communicate with the atomizing chamber 13. The generated smoke may be allowed to enter the smoke tunnel 212 from the second sub-tunnel 2122, and further exit from the first sub-tunnel 2121. In some embodiments, the extending direction of the first sub-tunnel 2121 may be substantially the same as the extending direction of the smoke outlet 11, and the extending direction of the second sub-tunnel 2122 may be different from the extending direction of the first sub-tunnel 2121.

As further shown in FIG. 3, the cover 21 may further include a first side surface 21a and a second side surface 21b opposite to the first side surface 21a. The second sub-tunnel 2122 may extend through the cover 21 from the first side surface 21a to the second side surface 21b. Further, in some embodiments, as shown in FIG. 3, the cover 21 may further include four inner walls 2122a connected end to end such that the second sub-tunnel 2122 may be formed or surrounded by these four inner walls 2122a.

Optionally, the extending direction of the second sub-tunnel 2122 may be substantially perpendicular to the extending direction of the first sub-tunnel 2121. In other words, the smoke tunnel 212 may be opened from the upper surface of the cover 21, and further extend through the first side surface 21a of the cover 21 and the second side surface 21b. The gap between the side surface of the cover 21 and the inner surface of the shell 10 may form part of the atomizing chamber 13. Since the extending directions of the first and second sub-tunnels 2121 and 2122 are not the same, the speed and the temperature of the smoke may be reduced in the smoke tunnel 212. Thus, the smoke exiting from the smoke outlet 11 and sucked by the user of the atomizer may be reduced to a proper temperature.

Referring to FIGS. 1, 2 and 5, in some embodiment, the heating assembly 20 may further include a chassis 25. The chassis 25 may be engaged inside the shell 10, and located at one side of the liquid guiding member 22 opposite to the first surface 222. The chassis 25 may be utilized to support the liquid guiding member 22 and the cover 21. For example, the chassis 25 and the cover 21 may both be engaged in the shell, and may cooperatively fix the liquid guiding member 22 therebetween. Thus, the heating assembly 20 is not allowed to move with respect to the shell 10.

In some embodiments, the chassis 25 may include a bottom wall 251 and a side wall 252 connected together. The side wall 252 and the bottom wall 251 may cooperatively define an installation space 253 for receiving part of the liquid guiding member 22 and part of the cover 21. In other words, when the cover 21, the liquid guiding member 22 and the chassis 25 are assembled, part of the cover 21 and part of the liquid guiding member 22 may be located in the installation space 253 defined in the chassis 25. In this circumstance, a portion of the installation space 253 is not occupied, and this portion of the installation space 253 is also part of the atomizing chamber 13 inside the shell 10. Optionally, the side wall 252 of the chassis 25 and the cover 21 may be connected by clamping. Specifically, a slot 2521 may be defined in the side wall 252 of the chassis 25, and a clip 213 corresponding to the slot 2521 may be formed on the outer surface of the cover 21. The clip 213 matches the slot 2521 such that the cover 21 may be fixed with the chassis 25. It should be understood, the chassis 25 and the cover 21 may be assembled in other ways in different embodiments.

In some embodiments, the bottom wall 251 of the chassis 25 may define at least one air entering hole 2511 extending therethrough. The air entering hole 2511 may communicate with the installation space 253. In other words, the air entering hole 2511 may communicate with the atomizing chamber 13. At the same time, the other end of the air entering hole 2511 may be interconnected with an air pipe (not shown). For example, the air pipe may have an opening formed in the side wall, top wall or bottom wall of the vaporization device. Air entering from the air entering hole 2511 may be mixed with smoke in the atomizing chamber 13, and then exit from the smoke outlet 11. By properly adjusting the size and shape of the air pipe and the air entering hole 2511, the ratio of the smoke to the air in the mixture generated may be controlled. Those of ordinary skill in the art should understand, the air entering hole and the air pipe may adopt any suitable arrangement, which is not limited in the present disclosure. For example, as shown in FIG. 5, there may be set of six air entering holes, which are radially arranged. In some embodiments, the chassis 25 may also be called a base.

In some embodiments, the diameter of the air entering hole(s) 2511 may be no larger than 0.2 mm. Experiments show that as long as the diameter of the air entering hole 2511 does not exceed 0.2 mm, fluid (if exists) leaking into the atomizing chamber 13 or formed by the condensation of smoke will not likely block the air entering hole 2511. Thus, the reliability of the atomizer may be improved.

In some embodiments, the bottom wall 251 may further define an installation hole 2512. The installation hole 2512 may be utilized for the installation of an electrode. The electrode may be utilized to connect the heating component 23 with an external battery.

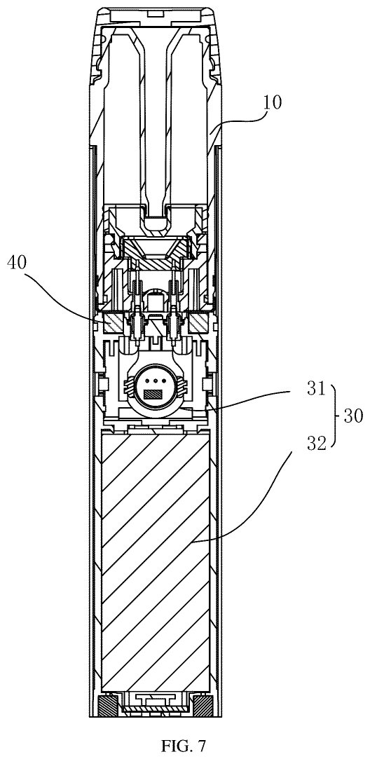

Referring to FIG. 7, the atomizer may further include a battery assembly 30. The battery assembly 30 may be disposed at and connected to one end of the shell 10 close to the heating component 23. The battery assembly 30 may be utilized to provide power to the heating component 23. Thus, the heating component 23 is capable of heating the liquid guiding member 22 when necessary.

In some embodiments, the shell 10 and the battery assembly 30 may be connected together by a magnet 40 disposed therebetween. The magnet 40 may connect the battery assembly 30 and the shell 10 by magnetic force.

As shown in FIG. 7, the battery assembly 30 may include a battery 32 and an air flow controller 31. The battery 32 may be utilized for powering the heating component 23 in the shell 10. The air flow controller 31 may be set in the path between the air entering hole 2511 and the outside environment. It is utilized to open the air flow path when the user uses the atomizer, and to close the air flow path when the user does not. Specifically, when a pressure drop is detected by the air flow controller 31, the air flow controller 31 may determine that the user is using the atomizer and may accordingly open the air flow path. Thus, air may enter into the atomizing chamber 13, be mixed with smoke and be provided to the user.

In another aspect, the present disclosure further provides an electronic cigarette. The electronic cigarette may include the atomizer of any embodiment described above. In operation, liquid smoke may be put in the liquid cavity 12. When a user uses the electronic cigarette, the liquid smoke may pass through the liquid tunnel 211 and arrive at the liquid guiding member 22, and then penetrate the liquid guiding member 22 under capillary action. During this process, the liquid smoke may be heated by the liquid guiding member 22 and the heating component 23 such that smoke may be generated in the atomizing chamber 13. The smoke in the atomizing chamber 13 may exit from the smoke tunnel 212 and the smoke outlet 11 interconnected with the atomizing chamber 13, and then be provided to the user. For simplicity and brevity, the structure of the electronic cigarette will not be repeated herein.

It should be understood, the structure of the atomizer (or the electronic cigarette) is not limited in the above-described embodiments. The atomizer may further include other components. For example, as shown in FIG. 1, the heating assembly 20 of the atomizer may further include a second sealing component 26 disposed in the gap between the cover 21 and the inner surface of the shell 10. The second sealing component 26 may be utilized to help the fixation of the cover 21 in the shell, and also to prevent fluid in the liquid cavity 12 from leaking into the lower part of the atomizer. Furthermore, the heating assembly 20 of the atomizer may also include an electrode 27 connected with the heating component 23 and extending to the outer surface (the bottom surface as shown in FIG. 1) of the shell 10. In this circumstance, when the shell 10 is connected with the battery assembly 30, the electrode 27 may be in contact with the electrode of the battery in the battery assembly 30. Thus, the battery assembly 30 may provide energy to the heating component 23 via the electrode 27.

The foregoing is merely embodiments of the present disclosure, and is not intended to limit the scope of the disclosure. Any transformation of equivalent structure or equivalent process which uses the specification and the accompanying drawings of the present disclosure, or directly or indirectly application in other related technical fields, are likewise included within the scope of the protection of the present disclosure.

What is claimed is:

1. An atomizer, comprising:
a liquid cavity, configured for storing a fluid to be vaporized;
a liquid guiding member, and a heating component in contact with the liquid guiding member;
a cover, being an integral structure, wherein a liquid tunnel and a smoke tunnel are defined at least partially in the cover, and the liquid tunnel is communicated with the liquid cavity and the liquid guiding member; and
a smoke outlet, communicated with the smoke tunnel, wherein smoke generated by heating the fluid is allowed to enter the smoke outlet through the smoke tunnel.

2. The atomizer of claim 1, wherein the smoke outlet is inserted into a part of the smoke tunnel, and the other part of the smoke tunnel is communicated with the smoke outlet and configured to be in direct contact with the smoke.

3. The atomizer of claim 1, wherein a cross-section of the liquid tunnel has a non-circular configuration.

4. The atomizer of claim 1, further comprising:
a base, wherein at least part of the liquid guiding member is located between the base and the cover.

5. The atomizer of claim 4, wherein the base comprises a bottom wall and a side wall connected together, the side wall and the bottom wall cooperatively define an installation space for receiving at least part of the liquid guiding member and/or at least part of the heating component.

6. The atomizer of claim 4, wherein a bottom wall of the base defines at least one air entering hole extending through the bottom wall and communicating with the installation space.

7. The atomizer of claim 6, wherein a diameter of the at least one entering hole is no larger than 0.2 mm.

8. The atomizer of claim 6, wherein the bottom wall of the base forms an air inlet, and the size of the air inlet is greater than the size of the at least one air entering hole.

9. The atomizer of claim 1, wherein the surface of the liquid guiding member on which the heating component is located is substantially planar.

10. The atomizer of claim 1, wherein the upper surface of the cover is substantially planar and starts the liquid tunnel and the smoke tunnel.

11. The atomizer of claim 1, wherein a surface of the heating component in direct contact with the liquid guiding member is substantially planar.

12. The atomizer of claim 1, wherein the smoke tunnel of the cover comprises a first sub-tunnel opened from the upper surface of the cover and a second sub-tunnel opened from a side surface of the cover, the extending direction of the first sub-tunnel is approximately parallel to the extending direction of the smoke outlet, and the extending direction of the second sub-tunnel is different from the extending direction of the first sub-tunnel.

13. The atomizer of claim 1, further comprising a shell, wherein the shell defines the smoke outlet and the liquid cavity, and the smoke outlet extends through the liquid cavity.

14. The atomizer of claim 1, wherein the cover, the liquid guiding member, and the heating component are located at an opening of the liquid cavity.

15. The atomizer of claim 1, wherein along the axial direction of the atomizer, the thickness of the cover is greater than the depth of the liquid tunnel and/or the depth of the smoke tunnel.

16. The atomizer of claim 1, further comprising a shell, wherein at least part of the cover is located between the shell and the liquid guiding member.

17. The atomizer of claim 1, wherein the cover comprises a top wall and a side wall.

18. The atomizer of claim 1, wherein the liquid tunnel extends to a first surface of the liquid guiding member, the heating component is arranged on a second surface of the liquid guiding member, and the second surface is opposite to the first surface.

19. The atomizer of claim 18, further comprising an electrode, wherein the electrode is connected with the heating component and exposed on the exterior of the atomizer.

20. An electronic cigarette, comprising:
a power supply; and
an atomizer, wherein the power supply is connected to the atomizer; and the atomizer comprises:
a liquid cavity, configured for storing a fluid to be vaporized;
a liquid guiding member, and a heating component, in contact with the liquid guiding member;
a cover, being an integral structure, wherein a liquid tunnel and a smoke tunnel are defined at least partially in the cover, and the liquid tunnel is communicated with the liquid cavity and the liquid guiding member; and
a smoke outlet, communicated with the smoke tunnel, wherein smoke generated by heating the fluid is allowed to enter the smoke outlet through the smoke tunnel.
